(19) United States
(12) Patent Application Publication
(10) Pub. No.: US 2009/0082935 A1
(43) Pub. Date: Mar. 26, 2009

(54) METHODS AND SYSTEMS TO CONTROL BRAKING OF A TRAILER HITCHED TO A VEHICLE

(75) Inventors: ROBERT W. LESCHUK, OXFORD, MI (US); JOHN F. LARSEN, CAMPBELLCROFT (CA)

Correspondence Address: INGRASSIA FISHER & LORENZ, P.C. (GM), 7010 E. COCHISE ROAD, SCOTTSDALE, AZ, 85253, US

(73) Assignee: GM GLOBAL TECHNOLOGY OPERATIONS, INC., DETROIT, MI (US)

(21) Appl. No.: 11/859,883

(22) Filed: Sep. 24, 2007

(51) Int. Cl. B60T 8/00

(52) U.S. Cl. 701/70

(57) ABSTRACT

A method for controlling braking of a trailer hitched to a vehicle with a braking control system during a braking event includes the steps of determining vehicle speed, measuring an amount of braking intent applied to the braking control system, determining a first level of braking output, providing the first level of braking output to the trailer if the vehicle speed is greater than a first predetermined threshold, and providing a second level of braking output to the trailer if the vehicle speed is less than the first predetermined threshold and the amount of braking intent has not exceeded a second predetermined threshold during the braking event. The first level of braking output corresponds to a function of the amount of braking intent. The second level of braking output is less than the first level of braking output.

### TECHNICAL FIELD

The present invention generally relates to the field of vehicles and, more specifically, to methods and systems for controlling braking of a trailer hitched to a vehicle.

### BACKGROUND OF THE INVENTION

A trailer brake controller (TBC) system of a vehicle controls braking output to brake units of a trailer that is hitched to the back of the vehicle. The braking output to the trailer brake units is generally reduced by the TBC when the vehicle speed is below a certain predetermined level during a braking event to improve the smoothness of the braking event. The reduction in braking output can result in longer stopping distances due to the reduction in braking output as the vehicle speed decreases. However, in certain situations, for example during a panic braking event, shorter stopping distances may be desired.

Accordingly, it is desired to provide systems for controlling braking of a trailer hitched to a vehicle that provide for shorter stopping distances under certain situations, such as a panic braking event. It is also desirable to provide methods for controlling braking of a trailer hitched to a vehicle that provide for shorter stopping distances under certain situations, such as a panic braking event. Furthermore, other desirable features and characteristics of the present invention will be apparent from the subsequent detailed description and the appended claims, taken in conjunction with the accompanying drawings and the foregoing technical field and background.

### SUMMARY OF THE INVENTION

In accordance with an exemplary embodiment of the present invention, a method for controlling braking of a trailer hitched to a vehicle with a braking control system during a braking event is provided. The method comprises the steps of determining a vehicle speed, measuring an amount of braking intent applied to the braking control system, determining a first level of braking output for the trailer, providing the first level of braking output to the trailer if the vehicle speed is greater than a first predetermined threshold, and providing a second level of braking output to the trailer if both of the following conditions are satisfied: the vehicle speed is less than the first predetermined threshold, and the amount of braking intent has not exceeded a second predetermined threshold during the braking event. The first level of braking output corresponds to a function of the amount of braking intent. The second level of braking output is less than the first level of braking output.

In accordance with another exemplary embodiment of the present invention, a program product for controlling braking of a trailer hitched to a vehicle with a braking control system during a braking event is provided. The program product comprises a program and a computer-readable signal-bearing media. The program is configured to at least facilitate determining a vehicle speed, measuring an amount of braking intent applied to the braking control system, determining a first level of braking output for the trailer, providing the first level of braking output to the trailer if the vehicle speed is greater than a first predetermined threshold, and providing a second level of braking output to the trailer if both of the following conditions are satisfied: the vehicle speed is less than the first predetermined threshold, and the amount of braking intent has not exceeded a second predetermined threshold during the braking event. The first level of braking output corresponds to a function of the amount of braking intent. The second level of braking output is less than the first level of braking output. The computer-readable signal-bearing media bears the program.

In accordance with a further exemplary embodiment of the present invention, a system for controlling braking of a trailer having a plurality of brake units and hitched to a vehicle having a braking control system during a braking event is provided. The system comprises a first sensing device, a second sensing device, and a brake controller. The first sensing device is configured to at least facilitate determining a vehicle speed. The second sensing device is configured to at least facilitate measuring an amount of braking intent applied to the braking control system. The brake controller is coupled to the first sensing device and the second sensing device, and is electronically coupled to the plurality of trailer brake units. The brake controller is configured to at least facilitate determining a first level of braking for the plurality of trailer brake units, causing the plurality of trailer brake units to apply the first level of braking if the vehicle speed is greater than a first predetermined threshold, and causing the plurality of trailer brake units to apply a second level of braking if both of the following conditions are satisfied: the vehicle speed is less than the first predetermined threshold, and the amount of braking intent has not exceeded a second predetermined threshold during the braking event. The first level of braking output corresponds to a function of the amount of braking intent. The second level of braking output is less than the first level of braking output.

### DESCRIPTION OF THE DRAWINGS

The present invention will hereinafter be described in conjunction with the following drawing figures, wherein like numerals denote like elements, and wherein:

FIG. 1 is a functional block diagram showing a system for controlling braking of a trailer hitched to a vehicle, shown along with certain portions of the vehicle and the trailer, in accordance with an exemplary embodiment of the present invention;

FIG. 2 is a flowchart of a process for controlling braking of a trailer hitched to a vehicle that can be implemented in connection with the system and the associated vehicle and trailer of FIG. 1 in accordance with an exemplary embodiment of the present invention;

FIG. 3 depicts a set of graphs illustrating operation of the system of FIG. 1 and the process of FIG. 2 in a first braking event scenario in which braking pressure never exceeds a predetermined braking pressure threshold in accordance with an exemplary embodiment of the present invention;

FIG. 4 depicts a set of graphs illustrating operation of the system of FIG. 1 and the process of FIG. 2 in a second braking event scenario in which braking pressure exceeds a predetermined braking pressure threshold before vehicle speed drops below a predetermined vehicle speed threshold in accordance with an exemplary embodiment of the present invention; and

FIG. 5 depicts a set of graphs illustrating operation of the system of FIG. 1 and the process of FIG. 2 in a third braking scenario in which braking pressure exceeds a predetermined braking pressure threshold after vehicle speed drops below a predetermined vehicle speed threshold in accordance with an exemplary embodiment of the present invention.

### DESCRIPTION OF AN EXEMPLARY EMBODIMENT

The following detailed description is merely exemplary in nature and is not intended to limit the invention or the application and uses of the invention. Furthermore, there is no intention to be bound by any expressed or implied theory presented in the preceding technical field, background, brief summary or the following detailed description.

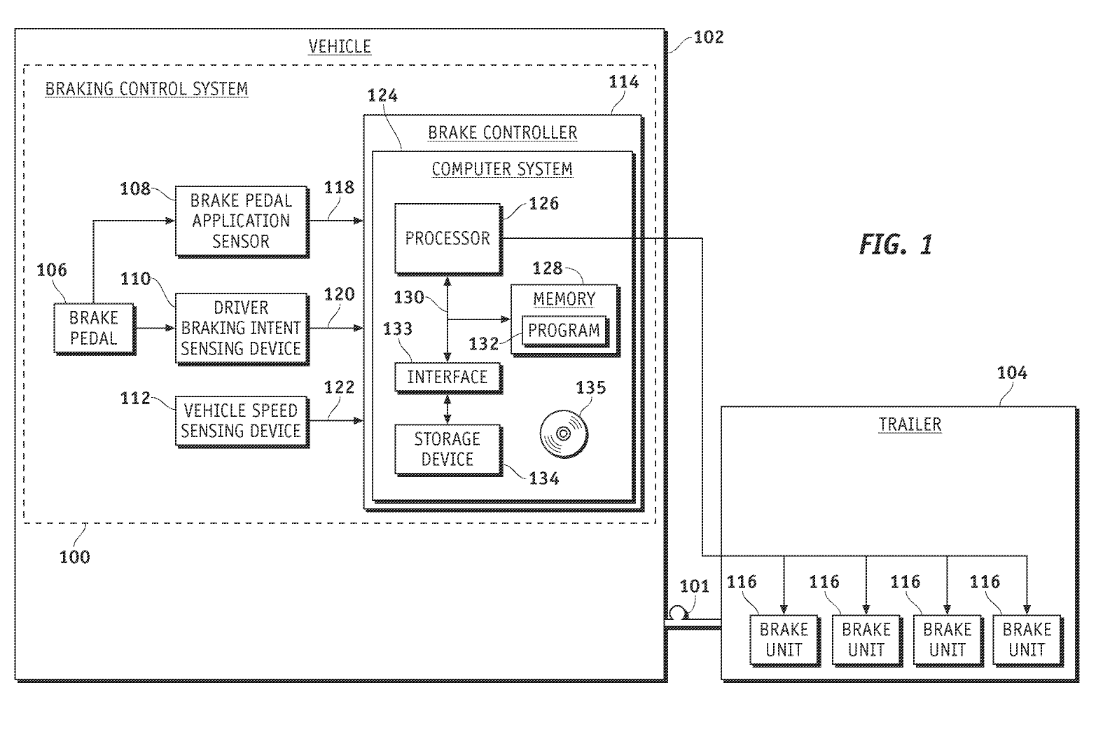

FIG. 1 is a functional block diagram showing an exemplary embodiment of a braking control system 100 in a vehicle 102 for controlling braking of a trailer 104 hitched to the vehicle 102 via a hitch 101. The braking control system 100 includes a brake pedal 106, a brake pedal application sensor 108, a braking intent sensing device 110, and a brake controller 114. The brake pedal 106 provides an interface between an operator of a vehicle and a brake system or a portion thereof, such as the braking control system 100, which is used to slow or stop the vehicle 102 and the trailer 104. To initiate the braking control system 100, an operator would typically use his or her foot to apply a force to the brake pedal 106 to move the brake pedal 106 in a generally downward direction. In one preferred embodiment the braking control system 100 is an electro-hydraulic system.

The brake pedal application sensor 108 and the braking intent sensing device 110 are coupled to the brake pedal 106. The brake pedal application sensor 108 senses whether an operator is currently applying force to the brake pedal 106, for example by sensing when an operator's foot is in contact with the brake pedal 106. In one exemplary embodiment, the brake pedal application sensor 108 activates a brake light activation switch when the vehicle operator is currently applying force to the brake pedal 106, although it will be appreciated that other types of brake pedal application sensors 108 may also be used.

The braking intent sensing device 110 senses one or more measures of braking intent by a driver of the vehicle 102. For example, in a preferred embodiment, the braking intent sensing device 110 senses braking pressure against the brake pedal 106. The braking intent sensing device 110 may include one or more pedal travel sensors, pedal force sensors, and/or other sensors, not depicted in FIG. 1. For example, one or more pedal travel sensors may provide an indication of how far the brake pedal 106 has traveled, which is also known as brake pedal travel, when the operator applies force to the brake pedal 106. In one exemplary embodiment, such brake pedal travel can be determined by how far a brake master cylinder input rod coupled to the brake pedal 106 has moved. Other methods of measuring brake travel can also be utilized. As another example, one or more brake pedal force sensors may determine how much force the operator of the braking control system 100 is applying to the brake pedal 106. This is also known as brake pedal force. In one exemplary embodiment, such a brake pedal force sensor may include a hydraulic pressure emulator and/or a pressure transducer, and the brake pedal force can be determined by measuring hydraulic pressure in a master cylinder of the braking control system 100. In certain embodiments, the braking pressure and/or other measure of braking intent may be determined by the braking intent sensing device 110 using a combination of brake pedal travel data, brake pedal force data, and/or other braking data.

The braking control system 100 also comprises a vehicle speed sensing device 112 that senses a speed at which the vehicle 102 is traveling. In one exemplary embodiment, the vehicle speed sensing device 112 may include one or more sensors disposed in or around one or more non-depicted wheels of the vehicle 102. In other embodiments, the vehicle speed sensing device 112 may include one or more sensors disposed inside the vehicle 102. In yet other embodiments, the vehicle speed sensing device 112 may include a combination of sensors disposed in the vehicle 102 as well as in or around one or more wheels of the vehicle 102.

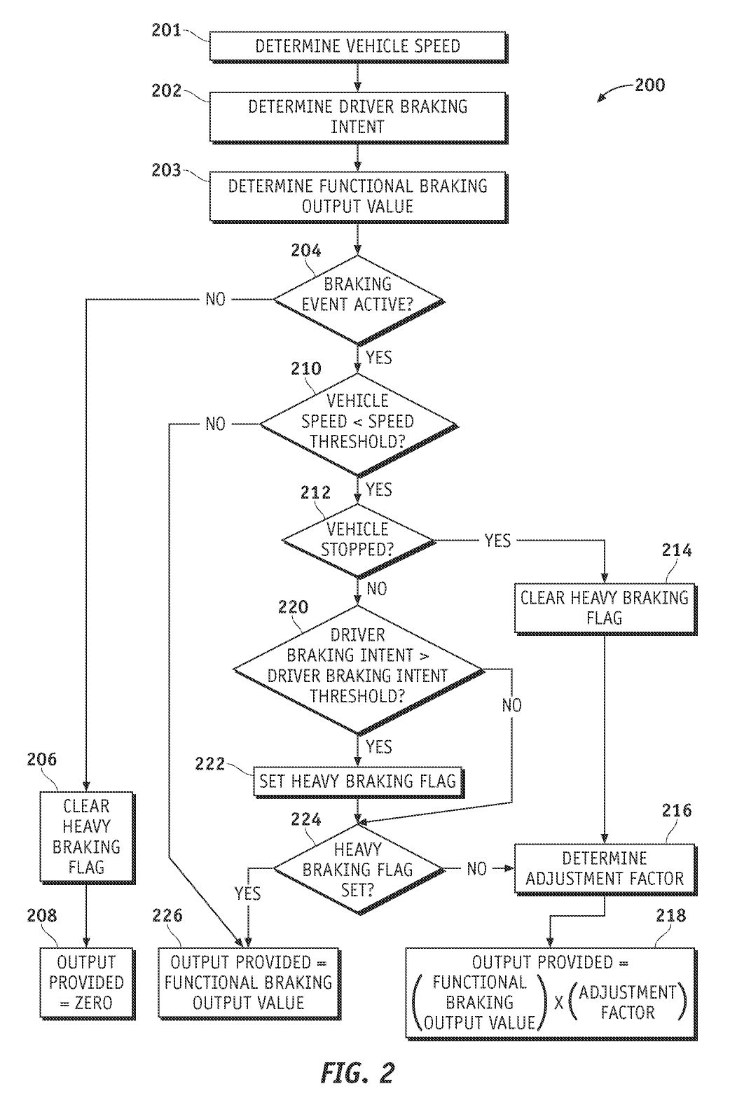

The brake controller 114 is coupled to the brake pedal application sensor 108, the braking intent sensing device 110 and the vehicle speed sensing device 112, as well as to brake units 116 of the trailer 104. The brake controller 114 receives a first input 118 from the brake pedal application sensor 108, namely brake pedal application data, a second input 120 from the braking intent sensing device 110, namely braking pressure data or another form of braking intent data, and a third input 122 from the vehicle speed sensing device 112, namely vehicle speed data. As described in more detail below, the brake controller 114 uses values from the first, second, and third inputs 118, 120, and 122 to perform various calculations, comparisons, and determinations, such as those described further below in connection with FIG. 2. The brake controller 114 uses such calculations, comparisons, and determinations in ultimately controlling the level of braking output provided to the brake units 116 of the trailer 104.

In the depicted embodiment, the brake controller 114 includes a computer system 124 that includes a processor 126, a memory 128, a bus 130, an interface 133, and a storage device 134. The processor 126 performs the computation and control functions of the brake controller 114, and may comprise any type of processor or multiple processors, single integrated circuits such as a microprocessor, or any suitable number of integrated circuit devices and/or circuit boards working in cooperation to accomplish the functions of a processing unit. During operation, the processor 126 executes one or more programs 132 preferably stored within the memory 128 and, as such, controls the general operation of the computer system 124.

The memory 128 stores a program or programs 132 that executes one or more embodiments of a braking control process of the present invention, discussed in more detail below. The memory 128 can be any type of suitable memory. This would include the various types of dynamic random access memory (DRAM) such as SDRAM, the various types of static RAM (SRAM), and the various types of non-volatile memory (PROM, EPROM, and flash). It should be understood that the memory 128 may be a single type of memory component, or it may be composed of many different types of memory components. In addition, the memory 128 and the processor 126 may be distributed across several different computers that collectively comprise the computer system 124. For example, a portion of the memory 128 may reside on a computer within a particular apparatus or process, and another portion may reside on a remote computer.

The bus 130 serves to transmit programs, data, status and other information or signals between the various components of the computer system 124. The bus 130 can be any suitable physical or logical means of connecting computer systems and components. This includes, but is not limited to, direct hard-wired connections, fiber optics, infrared and wireless bus technologies.

The interface 133 allows communication to the computer system 124, for example from a system operator and/or another computer system, and can be implemented using any suitable method and apparatus. It can include one or more network interfaces to communicate to other systems or components, for example the brake pedal 106, one or more terminal interfaces to communicate with technicians, and one or more storage interfaces to connect to storage apparatuses such as the storage device 134.

The storage device 134 can be any suitable type of storage apparatus, including direct access storage devices such as hard disk drives, flash systems, floppy disk drives and optical disk drives. In one exemplary embodiment, the storage device 134 is a program product from which memory 128 can receive a program 132 that executes one or more embodiments of a braking control process of the present invention. As shown in FIG. 1, the storage device 134 can comprise a disk drive device that uses disks 135 to store data. As one exemplary implementation, the computer system 124 may also utilize an Internet website, for example for providing or maintaining data or performing operations thereon.

It will be appreciated that while this exemplary embodiment is described in the context of a fully functioning computer system, those skilled in the art will recognize that the mechanisms of the present invention are capable of being distributed as a program product in a variety of forms, and that the present invention applies equally regardless of the particular type of computer-readable signal bearing media used to carry out the distribution. Examples of signal bearing media include: recordable media such as floppy disks, hard drives, memory cards and optical disks (e.g., disk 135), and transmission media such as digital and analog communication links. It will similarly be appreciated that the brake controller 114 may also otherwise differ from the embodiment depicted in FIG. 1, for example in that the brake controller 114 may be coupled to or may otherwise utilize one or more remote computer systems and/or other control systems.

The trailer brake units 116 are used to slow or stop the trailer 104. The trailer brake units 116 receive the brake commands from the brake controller 114, and are controlled thereby accordingly. The trailer brake units 116 can include any number of different types of devices that, upon receipt of brake commands, can apply the proper braking torque as received from the brake controller 114. For example, in an electro-hydraulic system, the trailer brake units 116 can comprise an actuator that can generate hydraulic pressure that can cause brake calipers to be applied to a brake disk to induce friction to stop a vehicle. Alternatively, in an electromechanical brake-by-wire system, the trailer brake units 116 can comprise a wheel torque-generating device that operates as a vehicle brake. The trailer brake units 116 can also be regenerative braking devices, in which case the trailer brake units 116, when applied, at least facilitate conversion of kinetic energy into electrical energy

FIG. 2 is a flowchart of an exemplary embodiment of a trailer braking control process 200 for controlling braking of a trailer hitched to a vehicle, and that can be implemented in connection with the braking control system 100 of FIG. 1. The trailer braking control process 200 utilizes a Heavy Braking Flag to indicate whether a measure of braking intent, such as braking pressure, has exceeded a predetermined braking intent threshold during a braking event, so that any appropriate adjustments can be made to the braking output provided to the trailer. In a preferred embodiment, the Heavy Braking Flag is initially set equal to zero, and is stored in the memory 128 of the computer system 124 of FIG. 1

As shown in FIG. 2, the trailer braking control process 200 begins by determining a speed of a vehicle to which a trailer is hitched (step 201). In a preferred embodiment, the vehicle speed is determined using the vehicle speed sensing device 112 of FIG. 1. In addition, a braking intent is also determined (step 202). In certain preferred embodiments, the braking intent represents braking pressure. In one such embodiment, the braking intent is represented by an amount of braking pressure desired by the driver of the vehicle, based at least in part on an amount of pressure exerted against the brake pedal 106 of FIG. 1. Also in a preferred embodiment, this braking pressure is determined by the braking intent sensing device 110 using brake pedal travel data and/or brake pedal force data. It will be appreciated that steps 201 and 202, along with various other steps of the trailer braking control process 200, may occur simultaneously or in either order. Preferably, steps 201 and 202 are performed continuously throughout an entire braking event. In certain embodiments, other measures of a driver braking intent may be used throughout the trailer braking control process 200 instead of or in addition to braking pressure.

A functional braking output value is then determined (step 203), representing an amount of braking output for the trailer that is based at least in part on the braking pressure or other measure of braking intent determined in step 202. Specifically, the functional braking output value is an amount of braking output provided to the trailer brake units 116 of FIG. 1 under normal braking conditions, for example in which there is not a panic braking situation or a similar situation in which a driver would need to apply an abnormally large amount of pressure on the brake pedal 106. The functional braking output value is determined as a function of the braking intent. In a preferred embodiment, the functional braking output value is calculated as a function of the braking pressure, so that the functional braking output value is proportional to the braking pressure. Also in a preferred embodiment, the functional braking output value is determined by the processor 126 of FIG. 1, using data from the braking intent sensing device 110 obtained via the second input 120.

Next, a determination is made as to whether a braking event is active (step 204). Specifically, a braking event is determined to be active if an operator is exerting pressure against the brake pedal 106. In a preferred embodiment, this determination is made by the processor 126 of FIG. 1, using braking pedal application data from the brake pedal application sensor 108 obtained via the first input 118. For example, the determination as to whether a braking event is active may include whether a brake light activation switch is activated, which occurs when the brake pedal application sensor 108 senses that an operator is currently applying force to the brake pedal 106.

If it is determined that a braking event is not active, then the above-mentioned Heavy Braking Flag is set equal to zero (step 206) if previously changed from zero, as discussed more fully below, indicating that the braking intent has not exceeded the predetermined braking intent threshold (for example, in a preferred embodiment, that the braking pressure has not exceeded a predetermined braking pressure threshold). In a preferred embodiment, the Heavy Braking Flag is set equal to zero by the processor 126 of FIG. 1. In addition, the braking output provided to the trailer brake units 116 is set equal to zero (step 208). Accordingly, no braking output is provided to the trailer brake units 116 under this scenario.

Alternatively, if it is determined that a braking event is active, then a determination is made as to whether the vehicle speed is less than a predetermined vehicle speed threshold (step 210). The predetermined vehicle speed threshold represents a relatively low level of vehicle speed, below which it is generally desirable to have reduced braking output provided to the trailer brake units 116 under ordinary conditions. For example, at vehicle speeds below the predetermined vehicle speed threshold, a reduction of the braking output provided to the trailer brake units 116 can provide for a smoother braking experience. In one preferred embodiment, the predetermined vehicle speed threshold is approximately ten miles per hour. However, this may vary, for example depending on the type of vehicle 102 and the type of trailer 104 hitched thereto. In a preferred embodiment, the predetermined vehicle speed threshold is stored in the memory 128 of the computer system 124 of FIG. 1, and the processor 126 makes the determination as to whether the vehicle speed is less than this threshold.

If it is determined that the vehicle speed is greater than or equal to the predetermined vehicle speed threshold, then braking output is provided to the trailer brake units 116 in an amount equal to the functional braking output value, which is preferably at least substantially proportional to the braking pressure or other measure of braking intent (step 226). Alternatively, if it is determined that the vehicle speed is less than the predetermined vehicle speed threshold, then the process proceeds through a number of additional steps to determine the appropriate amount of braking output for the trailer brake units 116, beginning with a determination as to whether the vehicle is stopped (step 212). In a preferred embodiment, this determination is made by the processor 126 of FIG. 1 using the vehicle speed measure determined in step 201.

If it is determined that the vehicle is stopped, then the Heavy Braking Flag is set equal to zero (or remains at zero) (step 214), and an adjustment factor is determined (step 216) for use in calculating the amount of braking output to be provided to the trailer brake units 116. In a preferred embodiment, the adjustment factor is based at least in part upon the vehicle speed, for example through the use of a look-up table or calculation. Also in a preferred embodiment, the adjustment factor is determined at least in part by the processor 126 of FIG. 1. Once the adjustment factor is determined, braking output is provided to the trailer brake units 116 in an amount equal to the functional braking output value multiplied by the adjustment factor (step 218). In a preferred embodiment, the adjustment factor is less than one, resulting in a reduction of braking output provided to the trailer brake units 116 (as compared to the functional braking output value), in order to provide a smoother braking experience.

Alternatively, if it is determined that the vehicle is not stopped, then a determination is made as to whether the braking intent is greater than a predetermined braking intent threshold (step 220). For example, in a preferred embodiment, the determination is made as to whether braking pressure is greater than a predetermined braking pressure threshold. In this embodiment, the predetermined braking pressure threshold is representative of an amount of braking pressure that would indicate a sense of urgency in braking, for example, a panic braking event. In such an event, the stopping distance for the trailer should be minimized, as this would typically outweigh the desire for a smoother braking experience under such conditions. In a preferred embodiment, this determination is made by the processor 126 of FIG. 1 using a braking pressure value determined in step 202 and comparing this figure with a value for a predetermined braking pressure threshold stored in the memory 128 of the computer system 124 of FIG. 1.

If it is determined that the braking intent is greater than the predetermined braking intent threshold, then the Heavy Braking Flag is set equal to one (step 222), which indicates that the braking intent has exceeded the predetermined braking intent threshold during the braking event (for example, in a preferred embodiment, that the braking pressure has exceeded a predetermined braking pressure threshold, in a preferred embodiment). In either event, the process proceeds with a determination as to whether the Heavy Braking Flag has been set during the braking event (step 224).

If it is determined that the Heavy Braking Flag has not been set to one, then the above-described adjustment factor is determined for calculating the amount of braking output to be provided to the trailer brake units 116 (step 216). As described above, in a preferred embodiment, the adjustment factor is determined by the processor 126 of FIG. 1 based at least in part upon the vehicle speed, for example through the use of a look-up table or calculation. Once the adjustment factor is calculated, braking output is provided to the trailer brake units 116 in an amount equal to the functional braking output value multiplied by the adjustment factor (step 218). Also as described above, in a preferred embodiment, the adjustment factor is less than one, resulting in a reduction of braking output provided to the trailer brake units 116 (as compared to the functional braking output value), in order to provide a smoother braking experience.

Alternatively, if it is determined that the Heavy Braking Flag has been set to one, then braking output is provided to the trailer brake units 116 in an amount equal to the functional braking output value, which is preferably at least substantially proportional to the braking intent (for example, braking pressure, in a preferred embodiment) (step 226). Specifically, under these conditions, minimizing the stopping distance of the trailer is of primary importance, and therefore the full functional braking output value is provided to the trailer brake units 116 even though the vehicle speed is less than the predetermined vehicle speed threshold.

Accordingly, in one exemplary embodiment of the trailer braking control process 200, there is no braking output provided to the trailer brake units 116 if there is no braking event (step 208). If there is a braking event, then braking output is preferably provided to the trailer brake units 116 in an amount that is at least substantially proportional to the braking pressure, or to some other measure of braking intent (step 226) until the vehicle speed drops below the predetermined vehicle speed threshold (as determined in step 210). Once the vehicle speed drops below the predetermined vehicle speed threshold, then the amount of braking output provided to the trailer brake units 116 is thereafter dependent on whether the braking intent has exceeded the predetermined braking intent threshold during the braking event (as determined in step 224). If the braking intent has not exceeded the predetermined braking intent threshold during the braking event, then a reduced braking output is provided to the trailer brake units 116 (step 218), to thereby provide a smoother braking experience. However, if the braking intent has exceeded the predetermined braking intent threshold during the braking event, then braking output preferably is provided to the trailer brake units 116 in an amount that is at least substantially proportional to the braking pressure or other measure of braking intent (step 226) to help minimize the stopping distance of the trailer under these circumstances.

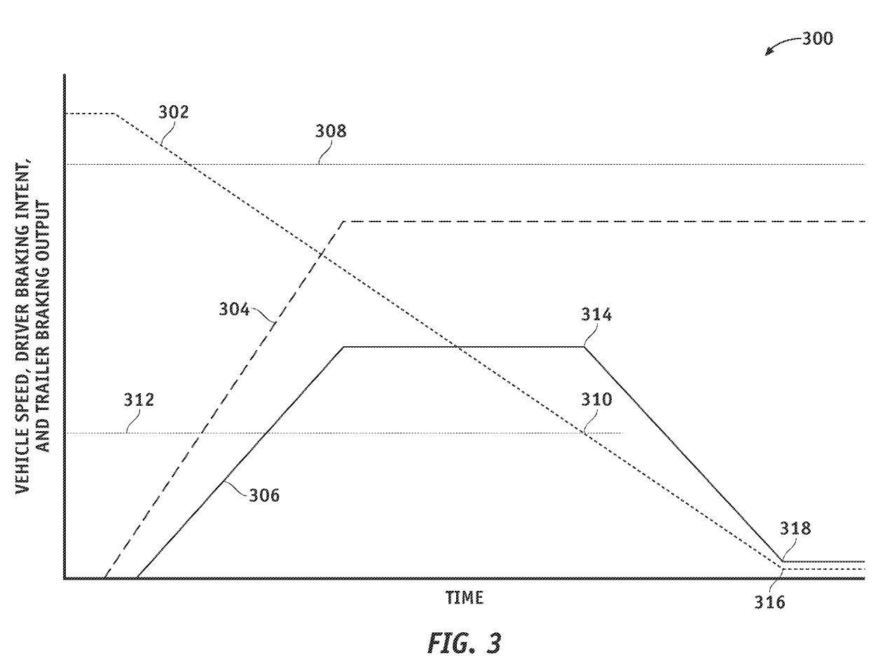

The trailer braking control process 200 of FIG. 2 is further described below in connection with FIGS. 3-5. Specifically, FIGS. 3-5 are graphical representations of different braking event scenarios in which a preferred embodiment of the trailer braking control process 200 is implemented, in which braking intent represents braking pressure.

First, FIG. 3 includes graphical representations of vehicle speed 302, braking pressure 304, and trailer braking output 306 (provided to the trailer brake units 116 of FIG. 1) in accordance with a first braking event 300. During the first braking event 300, the braking pressure 304 never exceeds a predetermined braking pressure threshold 308. As shown in FIG. 3, the trailer braking output 306 is proportional to the braking pressure 304 until the vehicle speed 302 drops below a predetermined vehicle speed threshold 312, specifically, at point 310 of FIG. 3. Once the vehicle speed 302 drops below the predetermined vehicle speed threshold 312 at point 310, the trailer braking output 306 is reduced by an adjustment factor (beginning at point 314 of FIG. 3), so that the trailer braking output 306 is no longer proportional to the braking pressure 304. As described above, this is done to provide a smoother braking experience. In the particular example of FIG. 3, the trailer braking output 306 decreases until points 316 and 318, at which the vehicle speed 302 and the trailer braking output 306, respectively, are both at least approximately equal to zero.

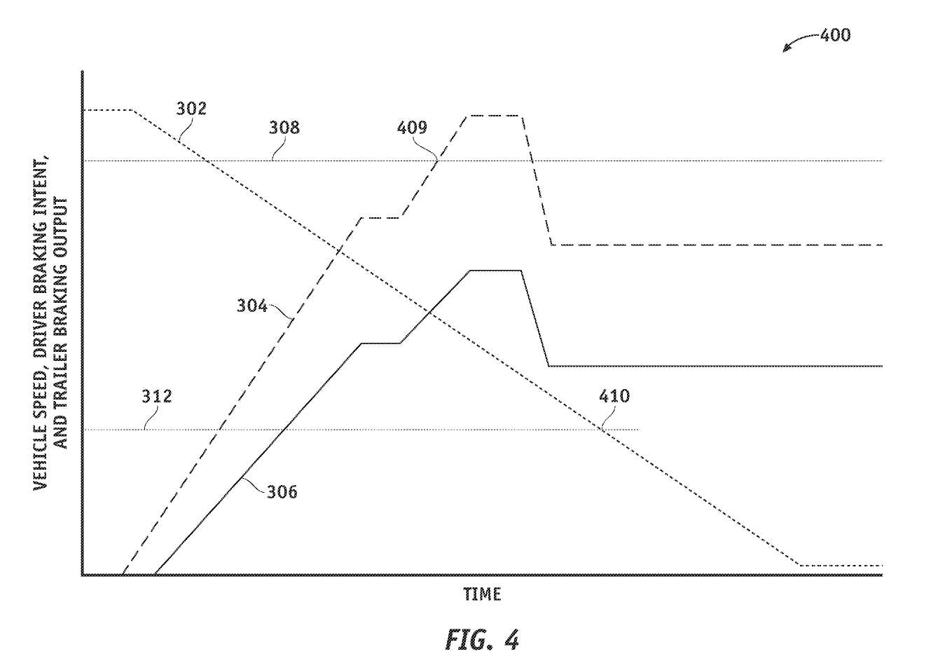

Turning now to FIG. 4, graphical representations of vehicle speed 302, braking pressure 304, and trailer braking output 306 are provided in accordance with a second braking event 400. During the second braking event 400, the braking pressure 304 exceeds the predetermined braking pressure threshold 308 (specifically, at point 409 of FIG. 4) before the vehicle speed 302 drops below the predetermined vehicle speed threshold 312 (specifically, at point 410 of FIG. 4). As shown in FIG. 4, the trailer braking output 306 is proportional to the braking pressure 304 throughout the entire second braking event 400, so as to minimize the stopping distance of the trailer 104 under these circumstances.

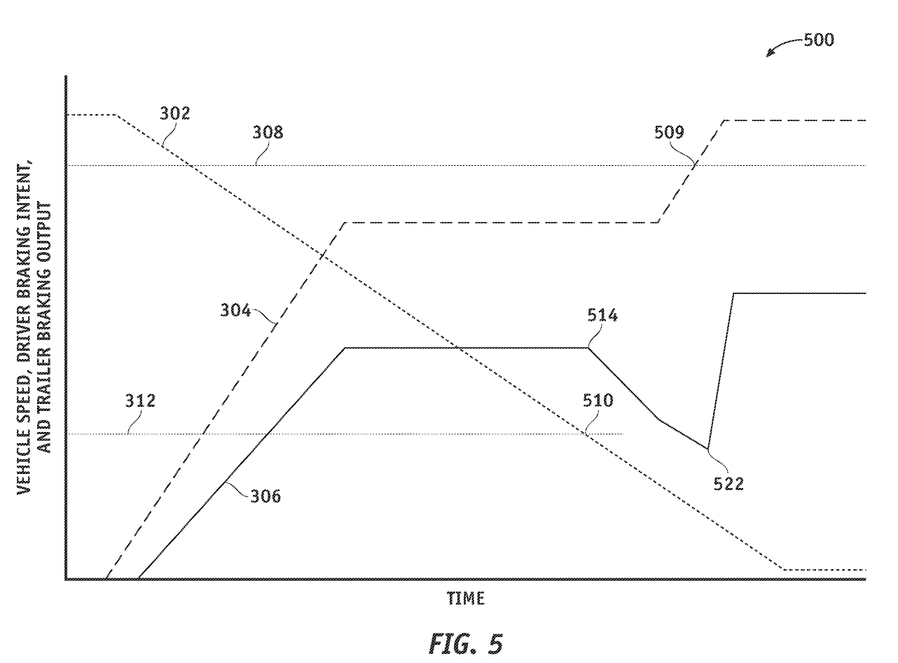

FIG. 5 provides graphical representations of vehicle speed 302, braking pressure 304, and trailer braking output 306 in accordance with a third braking event 500. During the third braking event 500, the braking pressure 304 exceeds the predetermined braking pressure threshold 308 (specifically, at point 509 of FIG. 5), but only after the vehicle speed 302 has dropped below the predetermined vehicle speed threshold 312 (specifically, at point 510 of FIG. 5). Initially, once the vehicle speed 302 drops below the predetermined vehicle speed threshold 312 at point 510, the trailer braking output 306 is reduced by an adjustment factor beginning at point 514 of FIG. 5, so that the trailer braking output 306 is no longer proportional to the braking pressure 304.

However, once the braking pressure 304 exceeds the predetermined braking pressure threshold 308 at point 509 of FIG. 5, the trailer braking output 306 is no longer reduced by the adjustment factor. Rather, beginning with a corresponding point 522 of FIG. 5, the trailer braking output 306 returns, preferably very quickly, to a level that is proportional to the braking pressure 304. As shown in FIG. 5, the trailer braking output 306 thereafter remains at a level that is proportional to the braking pressure 304 for the remainder of the third braking event 500, to thereby minimize the stopping distance for the trailer 104 under these circumstances.

Accordingly, a system and method for controlling braking of a trailer hitched to a vehicle is provided. The system and method provide smoother braking of the trailer under certain conditions, such as when the vehicle is traveling relatively slowly and there is no panic braking situation. The system and method also provide for shorter stopping distances for the trailer under certain other conditions, such as when there is a panic braking event or another reason for minimizing the stopping distance of the trailer as compared with stopping distances provided by other systems and methods in similar situations.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should be understood that various changes can be made in the function and arrangement of elements without departing from the scope of the invention as set forth in the appended claims and the legal equivalents thereof.

What is claimed is:

1. A method for controlling braking of a trailer hitched to a vehicle with a braking control system during a braking event, the method comprising the steps of:
determining a vehicle speed;
measuring an amount of braking intent applied to the braking control system;
determining a first level of braking output for the trailer corresponding to a function of the amount of braking intent;
providing the first level of braking output to the trailer if the vehicle speed is greater than a first predetermined threshold; and
providing a second level of braking output to the trailer, the second level being less than the first level, if both of the following conditions are satisfied:
the vehicle speed is less than the first predetermined threshold; and
the amount of braking intent has not exceeded a second predetermined threshold during the braking event.

2. The method of claim 1, wherein the step of measuring the amount of braking intent applied to the braking control system comprises the step of:
measuring an amount of braking pressure applied to the braking control system.

3. The method of claim 2, further comprising the step of:
providing a third level of braking output to the trailer, the third level being greater than the second level, if the following condition is satisfied:
after the second level of braking output is provided to the trailer, the amount of braking pressure exceeds the second predetermined threshold.

4. The method of claim 3, wherein the third level of braking output is at least approximately equal to the first level of braking output.

5. The method of claim 2, wherein the first level of braking output is at least substantially proportional to the amount of braking pressure.

6. The method of claim 1, wherein the step of providing the second level of braking output to the trailer comprises the steps of:
determining an adjustment factor that is based at least in part on the vehicle speed; and
determining the second level of braking output by multiplying the adjustment factor by the first level of braking output.

7. The method of claim 2, wherein:
the braking control system includes a brake pedal; and
the step of measuring the amount of braking pressure applied to the braking control system comprises determining a measure of force applied to the brake pedal.

8. The method of claim 2, wherein:
the braking control system includes a brake pedal; and
the step of measuring the amount of braking pressure applied to the braking control system comprises determining a measure of movement of the brake pedal.

9. A program product for controlling braking of a trailer hitched to a vehicle with a braking control system during a braking event, the program product comprising:
a program configured to at least facilitate:
determining a vehicle speed;
measuring an amount of braking intent applied to the braking control system;
determining a first level of braking output for the trailer corresponding to a function of the amount of braking intent;
providing the first level of braking output to the trailer if the vehicle speed is greater than a first predetermined threshold; and
providing a second level of braking output to the trailer, the second level being less than the first level, if both of the following conditions are satisfied:
the vehicle speed is less than the first predetermined threshold; and
the amount of braking intent has not exceeded a second predetermined threshold during the braking event; and
a computer-readable signal-bearing media bearing the program.

10. The program product of claim 9, wherein the amount of braking intent applied to the braking control system comprises an amount of braking pressure applied to the braking control system.

11. The program product of claim 10, wherein the program is further configured to at least facilitate providing a third level of braking output to the trailer, the third level being greater than the second level, if the following condition is satisfied:
after the second level of braking output is provided to the trailer, the amount of braking pressure exceeds the second predetermined threshold.

12. The program product of claim 11, wherein the third level of braking output is at least approximately equal to the first level of braking output.

13. The program product of claim 10, wherein the first level of braking output is at least substantially proportional to the amount of braking pressure.

14. The program product of claim 9, wherein the program is further configured to at least facilitate:
determining an adjustment factor that is based at least in part on the vehicle speed; and
determining the second level of braking by multiplying the adjustment factor by the first level of braking output.

15. A system for controlling braking of a trailer hitched to a vehicle with a braking control system during a braking event, the trailer including a plurality of trailer brake units, and the system comprising:
a first sensing device configured to at least facilitate determining a vehicle speed;
a second sensing device configured to at least facilitate measuring an amount of braking intent applied to the braking control system; and
a brake controller coupled to the first sensing device and the second sensing device, the brake controller electronically coupled to the plurality of trailer brake units and configured to at least facilitate:
determining a first level of braking for the plurality of trailer brake units corresponding to a function of the amount of braking intent;
causing the plurality of trailer brake units to apply the first level of braking if the vehicle speed is greater than a first predetermined threshold; and
causing the plurality of trailer brake units to apply a second level of braking, the second level being less than the first level, if both of the following conditions are satisfied:
the vehicle speed is less than the first predetermined threshold; and
the amount of braking intent has not exceeded a second predetermined threshold during the braking event.

16. The system of claim 15, wherein the amount of braking intent applied to the braking control system comprises an amount of braking pressure applied to the braking control system.

17. The system of claim 16, wherein the brake controller is further configured to cause the plurality of trailer brake units to apply a third level of braking, the third level being greater than the second level, if the following condition is satisfied:
after the plurality of trailer brake units are caused to apply the second level of braking, the amount of braking pressure exceeds the second predetermined threshold.

18. The system of claim 17, wherein the third level of braking is at least approximately equal to the first level of braking.

19. The system of claim 16, wherein the braking control system includes a brake pedal, and the first sensing device comprises:
a brake pedal force sensor configured to generate force data indicative of a magnitude of force applied to the brake pedal.

20. The system of claim 16, wherein the braking control system includes a brake pedal, and the second sensing device comprises:
a brake pedal travel sensor configured to generate travel data indicative of a measure movement of the brake pedal.
